(19) United States
(12) Patent Application Publication
(10) Pub. No.: US 2016/0139683 A1
(43) Pub. Date: May 19, 2016

(54) TOUCH PAD CONTROL SYSTEM

(71) Applicant: HON HAI PRECISION INDUSTRY CO., LTD., New Taipei (TW)

(72) Inventors: WEN-SHU DING, New Taipei (TW); CHIN-SHUANG LIU, New Taipei (TW)

(21) Appl. No.: 14/575,744

(22) Filed: Dec. 18, 2014

(30) Foreign Application Priority Data
Nov. 13, 2014 (TW) 103139453

(51) Int. Cl. G06F 3/038; G06F 3/02; G06F 1/16; G06F 3/0354

(52) U.S. Cl. CPC G06F 3/038; G06F 3/03547; G06F 3/0227; G06F 1/1662; G06F 1/169

(57) ABSTRACT

A touch pad control system includes a locking module, a control module, and an unlocking module. The touch pad control system is used in a notebook computer. The notebook computer includes a touch pad and a keyboard. The control module is configured to send a first locking signal and a second locking signal to the locking module after the keyboard is triggered. The locking module is configured to lock the touch pad after receiving the first locking signal and the second locking signal. The unlocking module is configured to unlock the touch pad.

### CROSS-REFERENCE TO RELATED APPLICATIONS

This application claims priority to Taiwanese Patent Application No. 103139453 Nov. 13, 2014, the contents of which are incorporated by reference herein.

### FIELD

The subject matter herein generally relates to a touch pad control system and in particular to a touch pad control system for a notebook computer.

### BACKGROUND

A touch pad control system in a notebook computer may be used to lock and unlock a touch pad.

### BRIEF DESCRIPTION OF THE DRAWINGS

Implementations of the present technology will now be described, by way of example only, with reference to the attached figures.

FIG. 1 is a block diagram of one embodiment of a touch pad control system.

FIG. 2 is a flowchart of one embodiment of the touch pad control system, and a touch pad is locked to a locked position.

FIG. 3 is similar to FIG. 2, but the touch pad is unlocked.

FIG. 4 is similar to FIG. 3, but the touch pad is locked.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to a touch pad control system to lock and unlock a touch pad in a notebook computer.

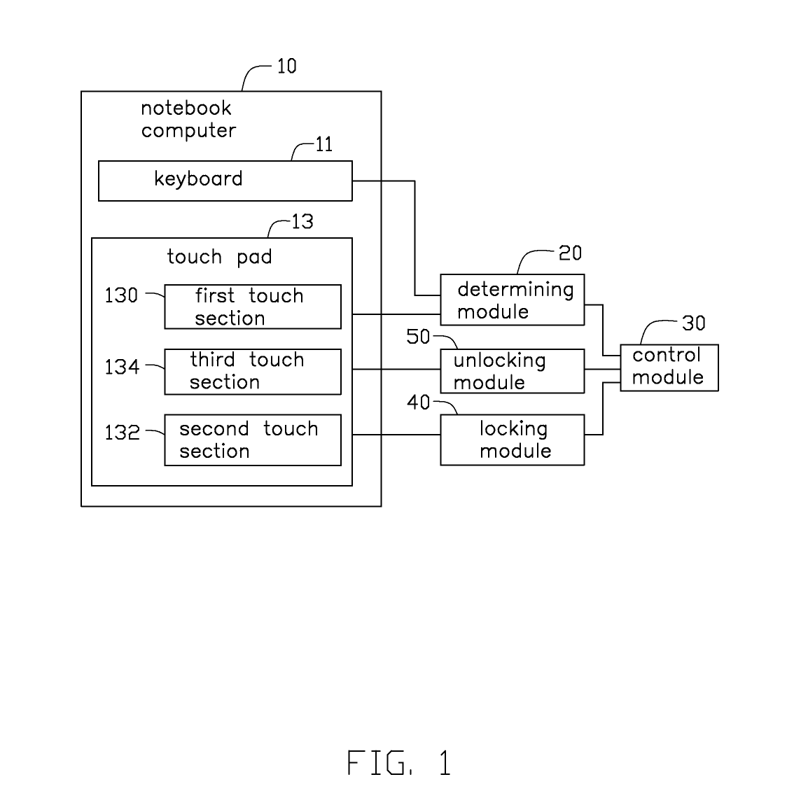

FIG. 1 illustrates an embodiment of a touch pad control system. The touch pad control system for a notebook computer 10 comprises a determining module 20, a control module 30, a locking module 40, and an unlocking module 50.

The notebook computer 10 comprises a keyboard 11 and a touch pad 13. The touch pad 13 comprises a first touch section 130, a second touch section 132, and a third touch section 134 located between the first touch section 130 and the second touch section 132. Users can input instructions to the notebook computer 10 via the first touch section 130, the second touch section 132, and the third touch section 134. The keyboard 11 is configured to input instructions to the notebook computer 10 after being triggered. The determining module 20 is configured to send a first locking signal and a second locking signal to the locking module 40 via the control module 30 when determining the keyboard 11 is triggered. In one embodiment, the first touch section 130 is configured to generate a mouse left-click event when triggered; the second touch section 132 is configured to generate a mouse right-click event when triggered. The determining module 20 is configured to determine an object (not shown) slides from the third touch section 134 to the first touch section 130 and determines the object slides from the third touch section 134 to the second touch section 132. In one embodiment, the object can be a finger or a touch stylist.

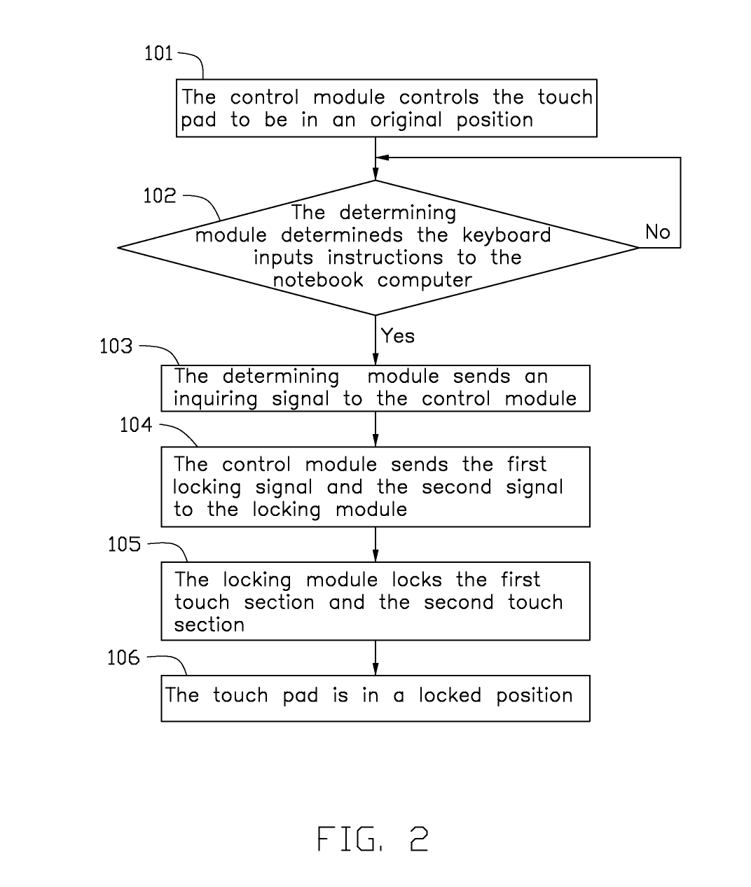

FIG. 2 illustrates a flowchart in accordance with an example embodiment. A method of the touch pad control system is provided by way of example, as there are a variety of ways to carry out the method. The method of the touch pad control system described below can be carried out using the configurations illustrated in FIG. 1, for example, and various elements of these figures are referenced in explaining method of the touch pad control system. In FIG. 2 each block represents one or more processes, methods, or subroutines carried out in the voice-recognition method. Additionally, the illustrated order of blocks is by example only and the order of the blocks can change. The method of the touch pad control system can begin at block 101.

At block 101, the control module 30 controls the touch pad to be in an original position.

At block 102, the determining module 20 determines the keyboard 11 to input instructions to the notebook computer 10.

At block 103, the determining module 20 sends an inquiring signal to the control module 30.

At block 104, the control module 30 sends the first locking signal and the second signal to the locking module 40.

At block 105, the locking module 40 locks the first touch section 130 and the second touch section 132.

At block 106, the touch pad 13 is in a locking position.

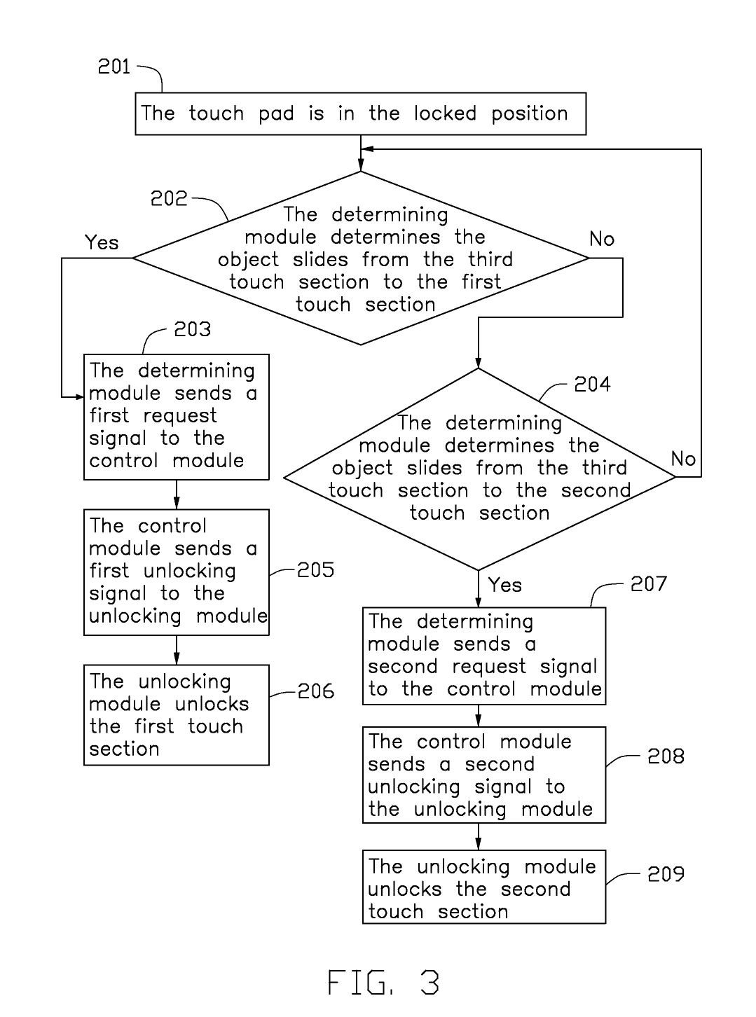

FIG. 3 illustrates a flowchart in accordance with an example embodiment. A method of the touch pad control system is provided by way of example, as there are a variety of ways to carry out the method. The method of the touch pad control system described below can be carried out using the configurations illustrated in FIG. 1, for example, and various elements of these figures are referenced in explaining method of the touch pad control system. In FIG. 3 each block represents one or more processes, methods, or subroutines carried out in the voice-recognition method. Additionally, the illustrated order of blocks is by example only and the order of the blocks can change. The method of the touch pad control system can begin at block 201.

At block 201, the touch pad 13 is in the locking position.

At block 202, the determining module 20 determines the object slides from the third touch section 134 to the first touch section 130.

At block 203, the determining module 20 sends a first request signal to the control module 30.

At block 204, the determining module 20 determines the object slides from the third touch section 134 to the second touch section 132.

At block 205, the control module 30 sends a first unlocking signal to the unlocking module 50.

At block 206, the unlocking module 50 unlocks the first touch section 130.

At block 207, the determining module 20 sends a second request signal to the control module 30.

At block 208, the control module 30 sends a second unlocking signal to the unlocking module 50.

At block 209, the unlocking module 50 unlocks the second touch section 132.

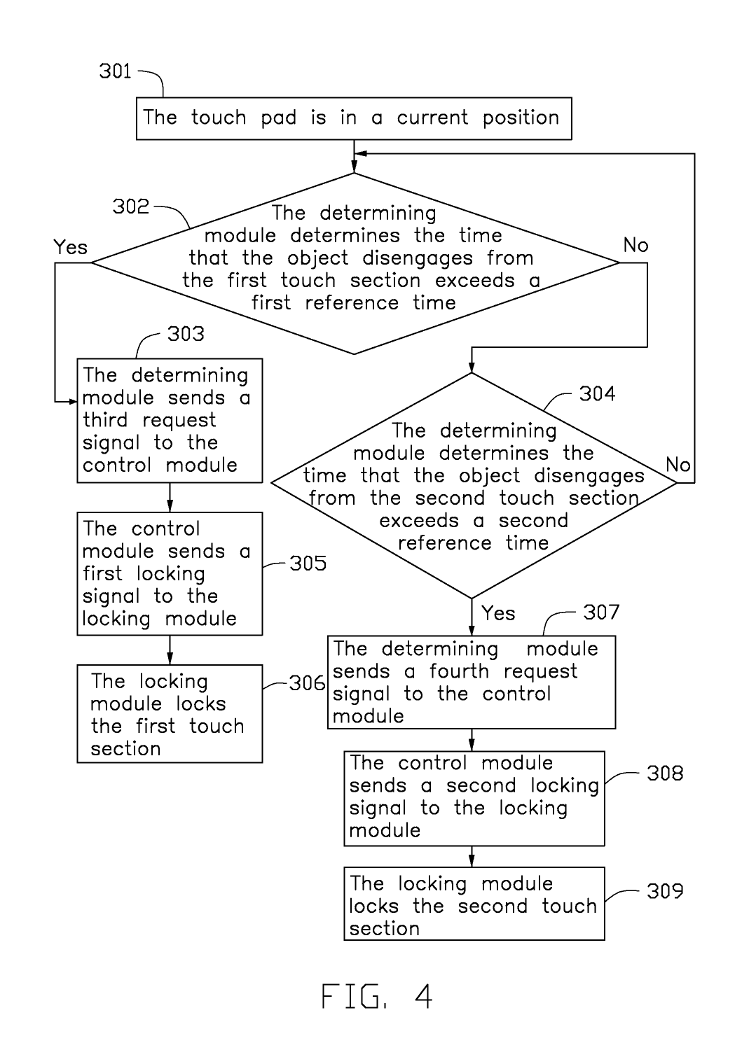

FIG. 4 illustrates a flowchart in accordance with an example embodiment. A method of the touch pad control system is provided by way of example, as there are a variety of ways to carry out the method. The method of the touch pad control system described below can be carried out using the configurations illustrated in FIG. 1, for example, and various elements of these figures are referenced in explaining method of the touch pad control system. In FIG. 4 each block represents one or more processes, methods, or subroutines carried out in the voice-recognition method. Additionally, the illustrated order of blocks is by example only and the order of the blocks can change. The method of the touch pad control system can begin at block 301.

At block 301, the touch pad 13 is in a current position.

At block 302, the determining module 20 determines the time that the object disengages from the first touch section exceeds a first reference time.

At block 303, the determining module 20 sends a third request signal to the control module 30.

At block 304, the determining module 20 determines the time that the object disengages from the second touch section 132 exceeds a second reference time.

At block 305, the control module 30 sends a first locking signal to the locking module 40.

At block 306, the locking module 40 locks the first touch section 130.

At block 307, the determining module 20 sends a fourth request signal to the control module 30.

At block 308, the control module 30 sends a second locking signal to the locking module 40.

At block 309, the locking module 40 locks the second touch section 132.

In the touch pad control system, when the keyboard 11 is used, the first touch section 130 and the second touch section 132 are in the locked position, thereby errors input to the notebook computer 10 can be avoided. When the first touch section 130 is used, a finger can be used to slide from the third touch section 134 to the first touch section 130 to unlock the first touch section 130. When the second touch section 132 is used by users, a finger can be used to slide from the third touch section 134 to the second touch section 132 to unlock the second touch section 132.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A touch pad control system comprising:
a locking module;
a control module; and
an unlocking module;
wherein the control module is configured to send a first locking signal and a second locking signal to the locking module after a keyboard is triggered, the locking module is configured to lock a touch pad after receiving the first locking signal and the second locking signal, and the unlocking module is configured to unlock the touch pad.

2. The touch pad control system of claim 1, wherein the touch pad comprises a first touch section and a second section, the control module is configured to control the unlocking module to unlock the first touch section after an object slides from the second touch section to the first touch section.

3. The touch pad control system of claim 2, wherein the touch pad further comprises a third touch section, the second section is located between the first touch section and the third touch section, and the control module is also configured to control the unlocking module to unlock the third touch section after the object slides from the second touch section to the third touch section.

4. The touch pad control system of claim 3, further comprises a determining module, wherein the determining module is configured to send a first request signal to the control module after determining the object slides from the second touch section to the first touch section and to send a second request signal to the control module after determining the object slides from the second touch section to the third touch section, and the control module is configured to control the unlocking module to unlock the first touch section after receiving the first request signal and control the unlocking module to unlock the third touch section after receiving the second request signal.

5. The touch pad control system of claim 4, wherein the determining module is also configured to send an inquiring signal to the control module after determining the keyboard is triggered, and the control module is configured to control the locking module to lock the first touch section and the third touch section after receiving the inquiring signal.

6. The touch pad control system of claim 5, wherein the control module is configured to send the first locking signal and the second locking signal to the locking module after receiving the inquiring signal, and the locking module is configured to lock the first touch section and the third touch section after receiving the first locking signal and the second locking signal.

7. The touch pad control system of claim 3, wherein the control module is configured to send a first unlocking signal to the unlocking module after receiving the first request signal and the unlocking module is configured to unlock the first touch section after receiving the first unlocking signal.

8. The touch pad control system of claim 3, wherein the determining module is configured to send a third request signal to the control module after determining the time that the object disengages from the first touch section exceeds a first reference time, and the control module is configured to control the locking module to lock the first touch section after receiving the third request signal.

9. The touch pad control system of claim 8, wherein the determining module is also configured to send a fourth request signal to the control module after determining the time that the object disengages from the third touch section exceeds a second reference time, and the control module is configured to control the locking module to lock the third touch section after receiving the fourth request signal.

10. The touch pad control system of claim 8, wherein the control module is configured to send the first locking signal to the locking module after receiving the third request signal and the locking module is configured to lock the first touch section after receiving the first locking signal.

11. A touch pad control system for a notebook computer comprising:
a locking module;
a control module; and
an unlocking module;
wherein the notebook computer comprises a touch pad and a keyboard, the touch pad is configured to input instructions to the notebook computer after being unlocked, the keyboard is configured to input instructions to the notebook computer after being triggered, the control module is configured to send a first locking signal and a second locking signal to the locking module after the keyboard is triggered, the locking module is configured to lock the touch pad after receiving the first locking signal and the second locking signal, and the unlocking module is configured to unlock the touch pad.

12. The touch pad control system of claim 11, further comprises a determining module, wherein the touch pad comprises a first touch section and a second section, the determining module is configured to send a first request signal to the control module after determining an object slides from the second touch section to the first touch section, and the control module is configured to control the unlocking module to unlock the first touch section after receiving the first request signal.

13. The touch pad control system of claim 12, wherein the touch pad further comprises a third touch section, the second section is located between the first touch section and the third touch section, the determining module is configured to send a second request signal to the control module after determining the object slides from the second touch section to the third touch section, and the control module is configured to control the unlocking module to unlock the third touch section after receiving the second request signal.

14. The touch pad control system of claim 13, wherein the determining module is also configured to send an inquiring signal to the control module after determining the keyboard is triggered, and the control module is configured to send the first locking signal after receiving the inquiring signal.

15. The touch pad control system of claim 11, further comprises a determining module, wherein the determining module is configured to send an inquiring signal to the control module after determining the keyboard is triggered, and the control module is configured to send the first locking signal and the second locking signal after receiving the inquiring signal.

16. The touch pad control system of claim 13, wherein the control module is configured to send a first unlocking signal to the unlocking module after receiving the first request signal and the unlocking module is configured to unlock the first touch section after receiving the first unlocking signal.

17. The touch pad control system of claim 16, wherein the control module is also configured to send a second unlocking signal to the unlocking module after receiving the second request signal and the unlocking module is configured to unlock the third touch section after receiving the second unlocking signal.

18. The touch pad control system of claim 13, wherein the determining module is configured to send a third request signal to the control module after determining the time that the object disengages from the first touch section exceeds a first reference time, and the control module is configured to send the first locking signal after receiving the third request signal.

19. The touch pad control system of claim 18, wherein the determining module is also configured to send a fourth request signal to the control module after determining the time that the object disengages from the third touch section exceeds a second reference time, and the control module is configured to control the locking module to send the second locking signal after receiving the fourth request signal.

20. The touch pad control system of claim 13, wherein the determining module is configured to send a third request signal and a fourth request signal to the control module after determining the time that the object disengages from the first touch section exceeds a first reference time, the control module is configured to send the first locking signal after receiving the third request signal, and the control module is also configured to send the second locking signal after receiving the fourth request signal.
